(19) United States
(12) Patent Application Publication
(10) Pub. No.: US 2012/0322370 A1
(43) Pub. Date: Dec. 20, 2012

(54) NEAR FIELD COMMUNICATION-ENABLED MOBILE COMMUNICATION TERMINAL AND METHOD OF CONTROLLING THE SAME

(75) Inventor: SANG HOON LEE, Gwanju (KR)

(73) Assignee: AQ CO., LTD., Seoul (KR)

(21) Appl. No.: 13/444,810

(22) Filed: Apr. 11, 2012

(30) Foreign Application Priority Data
Jun. 16, 2011 (KR) 10-2011-0058685

(51) Int. Cl. H04B 5/00

(52) U.S. Cl. 455/41.1

(57) ABSTRACT

Disclosed herein are a NFC-enabled mobile communication terminal and a method of controlling the same. The NFC-enabled mobile communication terminal is capable of performing short-range wireless communication with at least one NFC tag in reader mode. The NFC-enabled mobile communication terminal includes an NFC antenna for transmitting and receiving data recorded in the tag, an NFC controller for receiving the data the NFC antenna, a function control unit for receiving the data from the NFC controller and analyzing the data, and a terminal control unit for causing at least one function of the mobile communication terminal to be performed. The data is function control data including a command to perform the function. The function control unit extracts the command from the function control data, applies the command to the terminal control unit, and executes the command, thereby compulsorily controlling the function of the mobile communication terminal.

### CROSS REFERENCE TO RELAYED APPLICATION AND CLAIM OF PRIORITY

The present application claims the benefit of Korean patent application No. 10-2011-0058685 filed in the Korean Intellectual Property Office on Jun. 16, 2011, the entire content of which is incorporated herein by reference.

### BACKGROUND

1. Field of the Invention

The present invention relates generally to a Near Field Communication (NFC)-enabled mobile communication terminal and a method of controlling the same.

2. Description of the Related Art

In general, mobile communication terminals include a variety of functions, such as a ringing function for alerting incoming calls, a communication function for wirelessly sending and receiving voice and data signals, a camera function for capturing still and moving images, an MP3 function for playing back music files, a recording function for recording and playing back audio signals, a scanning function for copying and recording documents, an electronic book function for reading recorded text information, a note function, and a data terminal function, as well as a communication function for communicating with a wired/wireless terminal. Recently, mobile communication terminals have developed into smart phones equipped with a wireless Internet access function. This trend is expected to continue.

In particular, with the rapid spread of mobile communication terminals, most people possess a mobile communication terminal. Meanwhile, NFC technology has been applied to such mobile communication terminals, so that wireless data communication has become possible at low power over a short range.

A method of making payments using such an NFC function, like credit cards, is referred to as non-contact payment. Means for processing such non-contact payments is smartcard means. Recently, mobile communication terminals are generally equipped with a smartcard function.

Meanwhile, there are cases where persons carry mobile communication terminals equipped with the above-described variety of functions into silence requiring places, such as a conference room, a class room and a library, and generate ring tones audibly indicative of incoming calls, thereby offending other persons or obstructing corresponding programs.

In such limited areas, it is necessary to operate mobile communication terminals in silent mode or vibrate mode in order to prevent audible ring tones from being output.

Furthermore, there are cases where in places (hereinafter referred to as the “security areas”) where high-cost, new technology-related research, development and production are performed, such as laboratories, development rooms and factories, important confidential information is captured, recorded and/or scanned using the camera function, recording function and/or scanning function of mobile communication terminals without permission and is then divulged to the outside or rapidly transmitted to remote locations using the communication function of the mobile communication terminals.

In such security areas, it is necessary to perform automatic control so that one or more selected specific functions, such as a camera function, a recording function, a scanning function, a communication function, and/or a ringing function, of mobile communication terminals are turned off so as to maintain security.

### SUMMARY

Accordingly, at least one embodiment of the present invention has been made keeping in mind the above problems occurring in the prior art, and an object of the present invention is to provide an NFC-enabled mobile communication terminal and a method of controlling the same, which transmit and execute a command stored in a tag and configured to control at least one device configuration (for example, a camera, a vibrating configuration, a ringing configuration, a message output configuration, a call forwarding configuration, a recording configuration, and a scanning configuration), provided in the mobile communication terminal, via communication between the NFC-enabled mobile communication terminal and the NFC tag, thereby compulsorily controlling the device configuration of the mobile communication terminal.

According to an aspect of the present invention, an embodiment of the present invention provides a NFC-enabled mobile communication terminal capable of, in reader mode, performing short-range wireless communication with at least one NFC tag, wherein the NFC-enabled mobile communication terminal includes an NFC antenna for transmitting and receiving data recorded in the tag; an NFC controller for receiving the data recorded in the tag via the NFC antenna; a function control unit for receiving the data, read from the tag, from the NFC controller and analyzing the data; and a terminal control unit for causing at least one function of the mobile communication terminal to be performed; wherein the data recorded in the tag is function control data including a command to perform the function of the mobile communication terminal; and wherein the function control unit extracts the command from the function control data, applies the command to the terminal control unit, and executes the command included in the function control data, thereby compulsorily controlling the function of the mobile communication terminal.

The NFC controller may request ID information from the tag, check if the tag is a valid communicative object, initiates NFC communication with the tag, and apply function control data, read from the tag, to the function control unit.

The tag may include an ID information unit for storing ID information; a command format unit for storing the at least one command to control the function of the mobile communication terminal; and a tag communication unit for communicating with the mobile communication terminal in an NFC manner, and wirelessly transmitting and receiving function control data, including the ID information stored in the ID information unit and the command stored in the command format unit and configured to control the function of the mobile communication terminal, to and from the mobile communication terminal.

The command stored in the command format unit may include at least one of a command to turn off the function of the mobile communication terminal, a command to turn on the turned-off function of the mobile communication terminal, and a command to turn off the function of the mobile communication terminal and then turn on the function after a predetermined time has elapsed.

According to an aspect of the present invention, an embodiment of the present invention provides a method of controlling an NFC-enabled mobile communication terminal capable of performing NFC communication with a tag storing both II) information and at least one command to control at least one function of the mobile communication terminal, the method including a reader mode switching step of switching to reader mode for reading data stored in the tag; an ID information requesting step of, after the reader mode switching step, requesting the ID information from the tag; a response receiving step of, after the ID information requesting step, receiving a response from the tag; a session setup determining step of determining whether to set up a session with the tag by checking the ID information received at the response receiving step; a data receiving step of, if it is determined at the session setup determining step that the ID information is valid ID information, setting up the session and receiving the data from the tag; a command extracting step of extracting the command from the function control data, including the command to control the function of the mobile communication terminal, received at the data receiving step; a command executing step of applying the command, read at the command extracting step, to a terminal control unit for controlling functions of the mobile communication terminal, thereby executing the command; and a result outputting step of outputting results of the execution of the command, performed at the command executing step, via a display.

The command may include one or more of a command to turn off the function, a command to turn on the function, and a command to turn off the function and then turn on the function after a predetermined time has elapsed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a drawing illustrating an overview of an NFC-enabled mobile communication terminal and a method of controlling the same according to an embodiment of the present invention;

FIG. 2 is a block diagram illustrating the configuration of the NFC-enabled mobile communication terminal according to an embodiment of the present invention;

FIGS. 3A to 3C are block diagrams illustrating the configurations of tags according to an embodiment of the present invention;

FIG. 4 is a flow diagram illustrating a method of controlling the NFC-enabled mobile communication terminal according to an embodiment of the present invention;

FIG. 5 is a flowchart illustrating the mobile communication terminal operating step of the method of controlling the NFC-enabled mobile communication terminal according to an embodiment of the present invention; and

FIG. 6 is a flowchart illustrating the tag operating step of the method of controlling the NFC-enabled mobile communication terminal according to an embodiment of the present invention.

### DETAILED DESCRIPTION

Reference now should be made to the drawings, in which the same reference numerals are used throughout the different drawings to designate the same or similar components.

An NFC-enabled mobile communication terminal and a method of controlling the same according to embodiments of the present invention will be described in detail below with reference to the accompanying drawings.

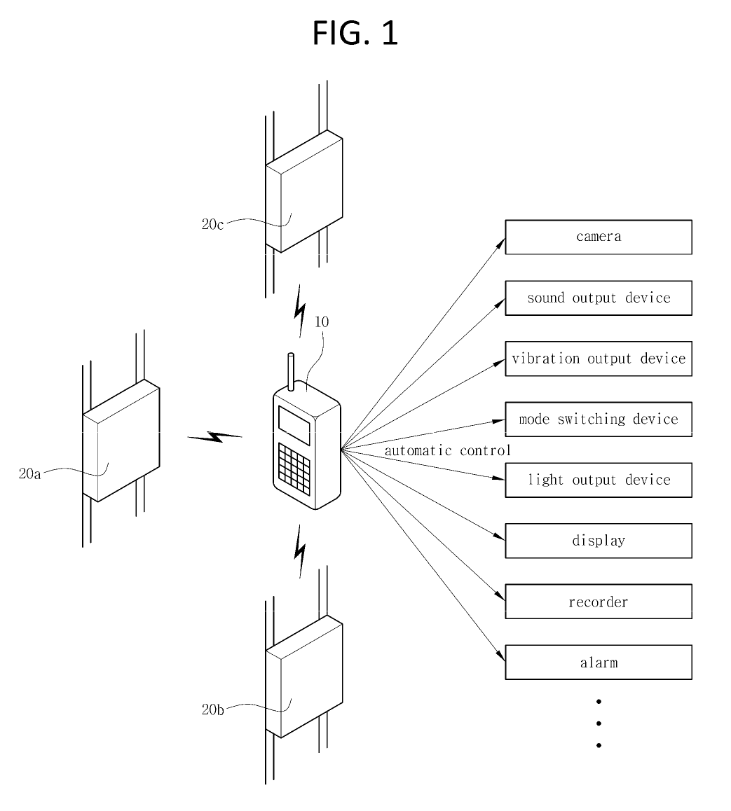

FIG. 1 is a drawing illustrating an overview of an NFC-enabled mobile communication terminal 10 and a method of controlling the same according to an embodiment of the present invention.

Referring to FIG. 1, the control device of the NFC-enabled mobile communication terminal 10 and the method of controlling the same according to an embodiment of the present invention are directed to compulsory control that is performed between the mobile communication terminal 10 and a tag 20 that communicate with each other using NFC. Here, the mobile communication terminal 10 is any one of mobile communication terminals including a mobile phone, a notebook computer, a smart phone, a Personal Digital Assistant (PDA), a Portable Multimedia Player (PMP), a netbook computer, and a tablet Personal Computer (PC).

The tag 20 stores a command to control at least one function of the mobile communication terminal 10 in a specific area or at a specific location, and provides function control data, including the command to compulsorily perform the corresponding function, to the NFC-enabled mobile communication terminal 10 that is authenticated using ID information.

That is, for example, the tag 20 is installed in a movie theater, and, when a movie viewer enters the theater, compulsorily switches the incoming call alert mode of the mobile communication terminal 10 of the movie viewer from ringer mode to vibrate mode via NFC between the tag 20 and the NFC-enabled mobile communication terminal 10, or turns off the camera function of the NFC-enabled mobile communication terminal 10.

For this purpose, the tag 20 stores at least one command to control the function of at least one device included in the mobile communication terminal 10. For example, the tag 20 includes at least one of a first tag 20a for sending a locking command to compulsorily turn off a function, a second tag 20b for sending an unlocking command to turn on a turned-off function, and a third tag 20c for sending a command to turn on a function a predetermined time after the issuance of a locking command.

The tags 20a, 20b and 20c that send a locking command and an unlocking command as described above are installed at the entrance and exit of a movie theater, and compulsorily turn off and on the ringing function of the mobile communication terminals 10 of movie viewers who enter into and exit from the movie theater. Furthermore, the ringing function of the mobile communication terminals 10 of movie viewers who exit from the movie theater which is turned off by compulsory control may be automatically turned on.

The detailed configuration and operation of the first to third tags 20a, 20b and 20c will be described later.

The mobile communication terminal 10 includes a plurality of devices that implement their functions. For example, in the mobile communication terminal 10, any one of a camera, a scanner, a sound input and output device, a vibration output device, a display, a light output device, and a data transmission and reception device is turned on or off in response to a function control command which is sent by the tag 20.

The mobile communication terminal 10 is provided with the above-described devices, and performs a variety of functions (hereinafter collectively referred to as the “function”) such as communication with a wired/wireless terminal, the capturing of images, the recording and playback of sounds, scanning, the turning on and off of ring tone and vibration output, the switching of reception mode (between vibrate mode and ringer mode), the capture and playback of moving images, wireless Internet access, the transmission and reception of text, and voice communication.

Here, the sound output device and vibration output device may include any or all of the devices that control and turn off the volume of sound for incoming calls and call reception, that output vibrations and ringtones, and/or that control and turn off sound that is output upon switching from vibrate mode to ringer mode, recording and playing back, and touching a keypad.

Furthermore, the light output device may include any or all of the light emission devices that emit light and function as an illuminating device and/or that control the brightness of the display and keypad of the mobile communication terminal 10.

The data transmission and reception device is a device that performs wireless communication between mobile communication terminals 10. Examples of the data transmission and reception device include an infrared communication device and a Bluetooth device that enable wireless communication between terminals proximate to each other. The above-described devices can be implemented in the mobile communication terminal 10. Furthermore, the above-described devices are controlled by a terminal control unit 14 controlling the mobile communication terminal 10, not by a NFC device performing NFC with the tags 20a, 20b and 20c.

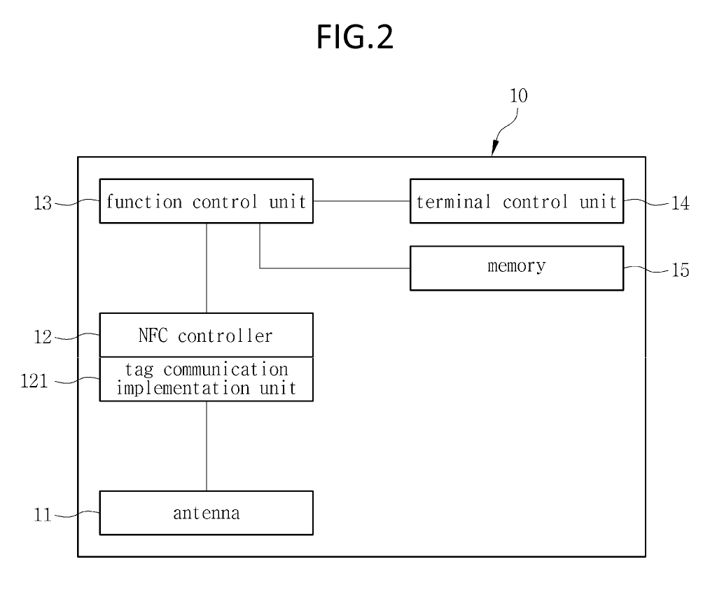

FIG. 2 is a block diagram illustrating the configuration of the NFC-enabled mobile communication terminal according to an embodiment of the present invention.

Referring to FIG. 2, the NFC-enabled mobile communication terminal 10 according to an embodiment of the present invention operates in reader mode, and performs NFC with the tag 20 in a one-to-one fashion. For this purpose, the mobile communication terminal 10 includes an antenna 11 for receiving data in a frequency band of, for example, 13.56 MHz within a short distance of, for example, about 10 centimeters, an NFC controller 12 for reading data stored in the tag 20, via the antenna 11, and performing wireless communication in an NFC manner, a function control unit 13 for analyzing function control data received from the NFC controller 12 and extracting a command, a terminal control unit 14 for controlling one or more devices mounted in the mobile communication terminal 10, and memory 15 for recording and storing the received function control data.

The antenna 11 receives data read from the tag 20 within a short distance of 10 centimeters and applies the data to the NFC controller 12, and sends a transmission signal, applied by the NFC controller 12, to the tag 20.

The NFC controller 12 includes a tag communication implementation module 121 that requests and checks the ID information of the tag 20. Here, the ID information (applet identifier (AID) information) is information that is used to identify a unique applet based on data format.

The NFC controller 12 is configured such that when it is located proximate to the tag 20, the tag communication implementation module 121 runs, requests the ID information from the tag 20, confirms that their data formats are the same, and then performs wireless communication with the tag 20.

The terminal control unit 14 controls one or more devices, such as a camera, a power source unit, a recorder, a player, a vibration output device, a sound output device, a display, a light output device, a device for performing wired/wireless data communication, and a device for performing the transmission and reception of calls and text between terminals, which are mounted in the mobile communication terminal 10. Here, the terminal control unit 14 receives a command from the function control unit 13, and executes the command, for example, to compulsorily turn on or off, or turn off and, after a predetermined period, turn on any one of the mounted devices that performs a corresponding function.

The function control unit 13 extracts a command from the function control data received from the NFC controller 12, and applies the command to the terminal control unit 14. Here, the function control unit 13 stores the function control data, applied by the NFC controller 12, in the memory 15, analyzes the stored function control data, and extracts the command. Furthermore, the function control unit 13 applies the extracted command to the terminal control unit 14.

For example, the function control unit 13 analyzes whether the command is related to turning off of a camera, the turning off of ringer mode, the turning off of a display, the turning off of vibration output, the turning off of a recorder, or the turning off of a speaker, and applies the command to the terminal control unit 14.

Furthermore, the function control unit 13 applies a command to output the execution of the command by the terminal control unit 14 and the results of the execution via a display in the form of text to the terminal control unit 14.

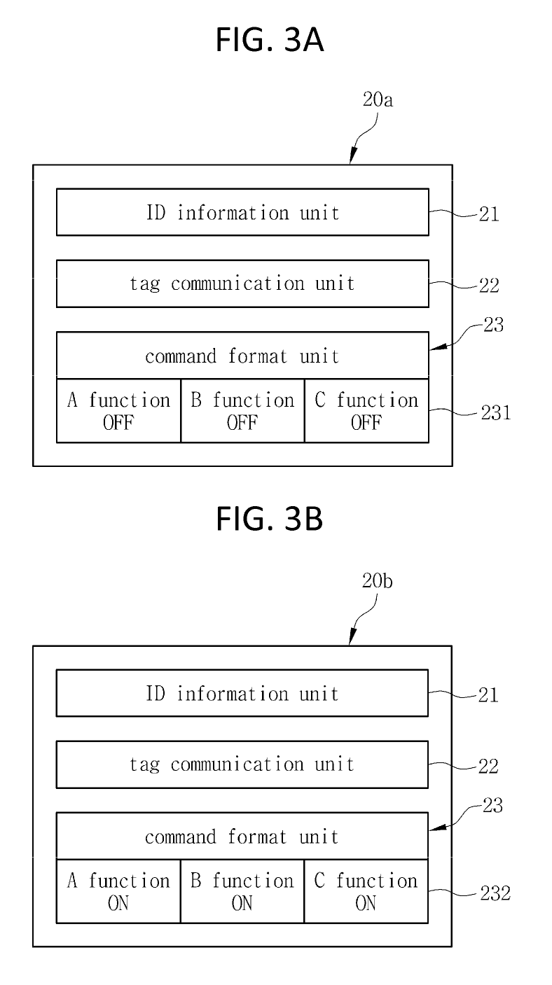

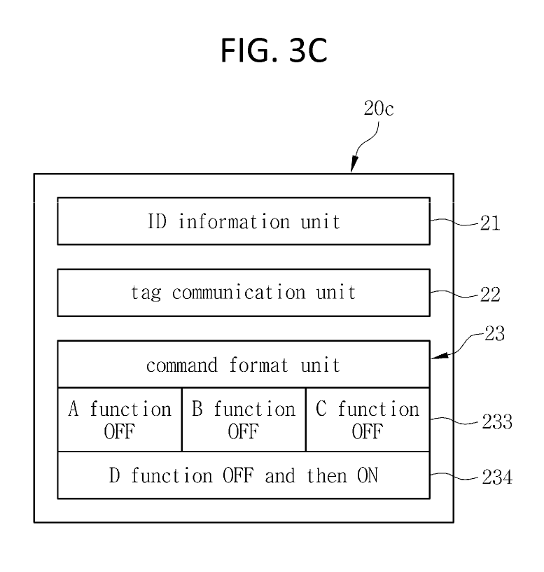

FIGS. 3A to 3C are block diagrams illustrating the tags 20a, 20b, 20c according to an embodiment of the present invention.

Referring to FIGS. 3A to 3C, each of the tags 20 according to an embodiment of the present invention stores a command to control the function of a device mounted in the reader (mobile communication terminal 10), and sends function control data, including the command, to the mobile communication terminal 10 when it sets up a session with the mobile communication terminal 10 and receives a data request signal.

For this purpose, the first tag 20a includes an ID information unit 21 for storing ID information, a command format unit 23 for storing a command to control the function of the mobile communication terminal 10, and a tag communication unit 22 for communicating with the mobile communication terminal 10 in an NFC manner, and sends function control data, including ID information stored in the ID information unit 21 and a command stored in the command format unit 23 and configured to control a function of the mobile communication terminal 10.

Of the above units, the command format unit 23 includes a command storage module 231, 232 or 233 for storing at least one command to control a function of the mobile communication terminal 10, and a switching command module 234 for storing a command to release the first command stored in the command storage module 231.

The tag according to an embodiment of the present invention may be one or more of the first tag 20a containing a locking command, the second tag 20b containing an unlocking command, and the third tag 20c containing a command to perform unlocking after performing locking.

For example, the command storage module 231 of the first tag 20a contains locking commands such as “A function OFF,” “B function OFF” and “C function OFF.”

For example, the command storage module 232 of the second tag 20b contains unlocking commands such as “A function ON,” “B function ON” and “C function ON.”

For example, the third tag 20c includes the command storage module 233 containing commands such as “A function OFF,” “B function OFF” and “C function OFF,” and a switching command module 234 containing switching commands that switch the commands contained in the command storage module, such as “A function ON after time E,” “B function ON after time E” and “C function ON after time E.”

The above-described first to third tags 20a, 20b and 20c may be selectively used depending on the characteristics of a surrounding environment or place. The mobile communication terminal 10 performs control so that a corresponding function is compulsorily turned on or off, or turned off and then turned on after a predetermined time in compliance with a command from one of the first to third tags 20a, 20b and 20c.

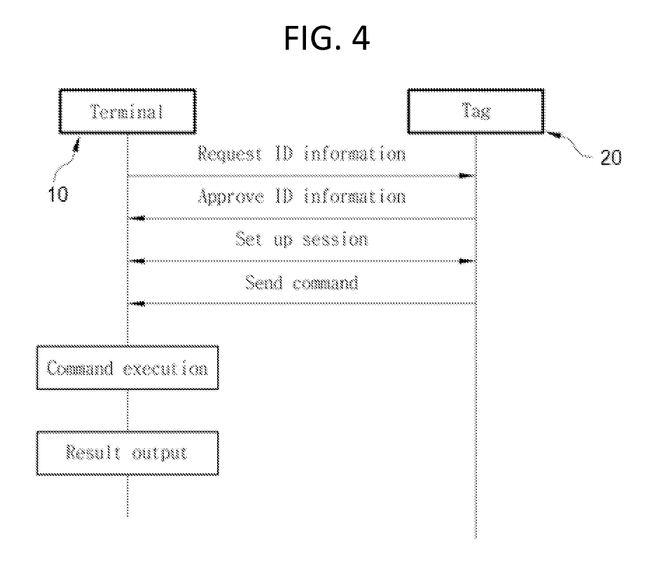

The NFC-enabled mobile communication terminal 10 according to an embodiment of the present invention includes the tags 20 and the mobile communication terminal 10. A method of controlling the NFC-enabled mobile communication terminal 10, which is performed using the above-described configuration, will be described in detail below with reference to FIGS. 4 to 6.

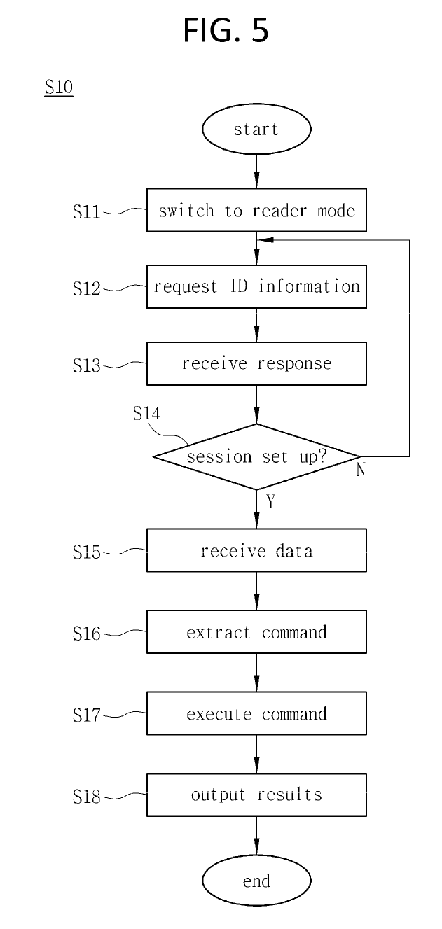

FIG. 4 is a flow diagram illustrating the method of controlling the NFC-enabled mobile communication terminal 10 according to an embodiment of the present invention, and FIG. 5 is a flowchart illustrating the mobile communication terminal operating step of the method of controlling the NFC-enabled mobile communication terminal 10 according to an embodiment of the present invention.

Referring to FIGS. 4 and 5, the method of controlling the NFC-enabled mobile communication terminal 10 according to an embodiment of the present invention includes tag operating step S20 of operating the tag 20 that stores ID information and a command to control the function of a device mounted in the mobile communication terminal 10 and sends the data to the mobile communication terminal 10, and communication terminal operating step S10 of communicating with the tag 20 in an NFC manner and controlling the function of the device in compliance with the function control command.

Of these steps, the mobile communication terminal operating step S10 includes reader mode switching step Sll of switching to reader mode for reading data stored in the tag 20, ID information requesting step S12 of, after the reader mode switching step S11, requesting ID information from the tag 20, response receiving step S13 of, after the ID information requesting step S12, receiving a response from the tag 20, session setup determining step S14 of checking the ID information received at the response receiving step S13 and determining whether to set up a session with the tag 20, data receiving step S15 of setting up a session if it is determined at the session setup determining step S14 that the ID information is valid, and receiving data from the tag 20, command extracting step (also referred to as command reading step) S16 of extracting a device control command from the function control data, including the device control command, received at the data receiving step S15, command executing step S17 of the command extracting step S16 of executing the read command related to a corresponding function, and result outputting step S18 of outputting the results of executing the command at the command executing step via a display.

The reader mode switching step S11 is the step of switching to reader mode to read data stored in the tag 20. In this case, when a user selects the reader mode using a keypad, the selection signal is applied to the function control unit 13 via the terminal control unit 14. Accordingly, the function control unit 13 controls the NFC controller 12 so that the NFC-enabled mobile communication terminal 10 operates in the reader mode.

The ID information requesting step S12 is the step at which the NFC controller 12 which has switched to the reader mode under the control of the function control unit 13 at the reader mode switching step Sll reads ID information from the adjacent tag 20 via the antenna 11. Here, the NFC controller 12 requests the ID information via the tag communication implementation module 121.

The response receiving step S13 is a step at which the NFC controller 12 receives a response to the ID information request from the tag 20. The NFC controller 12 receives the ID information from the tag 20, and checks if the received ID information is identical to the set ID information.

The session setup determining step S14 is the step of determining whether wireless communication with the tag 20 is possible by checking the ID information received by the NFC controller 12 at the response receiving step S13.

The data receiving step S15 is the step at which the NFC controller 12 reads data from the tag 20. Here, the data read from the tag 20 is function control data including a command to control one function implemented in the mobile communication terminal 10. The function control unit 13 records the function control data, applied via the NFC controller 12, in the memory 15.

The command extracting step S16 is a step at which the function control unit 13 analyzes the function control data recorded in the memory 15 and extracts the command from the function control data. Here, the function control data recorded in the memory 15 is encrypted. Accordingly, the function control unit 13 decrypts the function control data encrypted and then recorded in the memory 15, and then reads the command. Here, the function control unit 13 analyzes whether the tag 20 includes a locking, unlocking or unlocking-after-locking command.

The command executing step S17 is the step of compulsorily controlling the corresponding function by applying the command read from the function control unit 13 to the terminal control unit 14. Here, the terminal control unit 14 operates a corresponding device in compliance with the command applied by the function control unit 13. For example, a device that implements a function selected from among functions, such as switching to vibrate mode in case of an incoming call, the turning off of a camera, and the turning off of a recorder is compulsorily turned off.

Here, the terminal control unit 14 checks whether a command in question is a locking command from the first tag 20a or an unlocking command from the second tag 20b, and turns off or on a corresponding function. Furthermore, the terminal control unit 14, if the command in question is an unlocking-after-locking command in which commands stored in the command storage module 233 and switching command module 234 of the third tag 20c were combined, turns off a corresponding function first and then turns on the function after a predetermined time has elapsed.

The result outputting step S18 is a step at which the function control unit 13 issues a command to output the function controlled at the command executing step S17 and the results of the control of the function via the display of the mobile communication terminal 10. For example, the function control unit 13, if the camera has been compulsorily turned off at command executing step S17, issues a result output command to output the message “camera has been turned off” to the terminal control unit 14 via the display.

Accordingly, the terminal control unit 14 may cause the text input device to generate the above sentence in compliance with the result output command from the function control unit, and outputs the generated sentence to the display.

For example, in the case where settings are set such that the command executed at the command executing step S17 is switched in compliance with a switching command (which will be described), for example, when a user enters a movie theater and incoming call alert mode is switched from the ringer mode of the command executing step S17 to vibrate mode, the message “ringing is turned off and will be turned on 2 hours later” may be output.

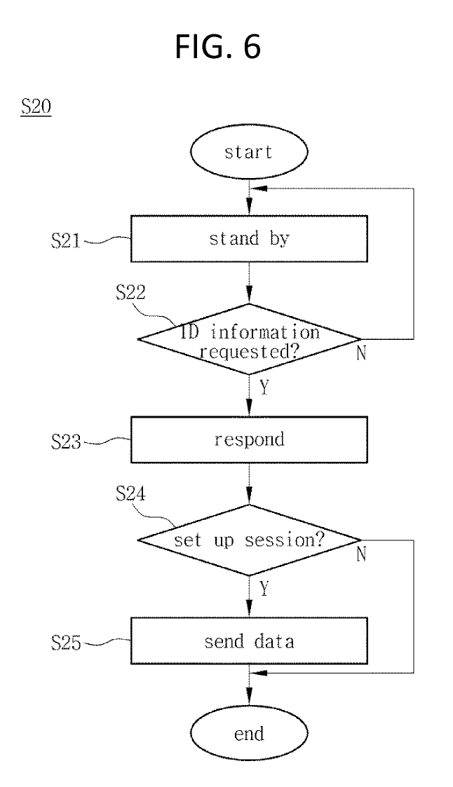

Furthermore, the present invention includes the tag operating step in addition to the mobile communication terminal operating step. The tag operating step will be described in detail below with reference to FIG. 6.

FIG. 6 is a flowchart illustrating the tag operating step of the method of controlling the NFC-enabled mobile communication terminal 10 according to an embodiment of the present invention.

Referring to FIG. 6, the tag operating step includes standby step S21, ID information request determination step S22 of determining whether an ID information request signal is applied by the mobile communication terminal 10, response step S23 of, when it is determined at the ID information request determination step S22 that the ID information request has been received, sending ID information, session setup step S24 of setting up a session with the mobile communication terminal 10 after the response step S23, and command transmitting step S25 of sending function control data including a command to control a function after the session setup step S24.

The ID information request determination step S22 is the step of determining whether an ID information request signal has been received from the mobile communication terminal 10. Here, the tag communication unit 22 of the tag 20 receives the ID information request signal transmitted from the antenna 11.

The response step S23 is a step at which the tag communication unit 22 reads the ID information stored in the ID information unit 21 and sends the ID information to the mobile communication terminal 10.

The session setup step S24 is the step of determining whether ID information stored in the mobile communication terminal 10 is identical to the ID information transmitted at the response step S23 and a session is set up between both parties.

The command transmitting step S25 is the step of, after the session setup step S24, sending function control data stored in the command format unit 23. The function control data may include at least one of locking, unlocking and unlocking-after-locking commands to control a function that is implemented in the mobile communication terminal 10.

That is, the first tag 20a sends a locking command to turn off a function of the mobile communication terminal 10, the second tag 20b sends an unlocking command to turn on a turned-off function of the mobile communication terminal 10, and the third tag 20c sends an unlocking-after-locking command to turn off a function of the mobile communication terminal 10 and then turn on the function after a predetermined time has elapsed.

As described above, one or more of the embodiments of the present invention are configured such that the tag 20 stores a command to compulsorily store a device of the mobile communication terminal 10 and a function of the mobile communication terminal 10 is compulsorily controlled in accordance with the characteristics of each place, so that it can be widely utilized because the use of the mobile communication terminal 10 can be prevented from inconveniencing the general public and secrets are prevented from being divulged at a place requiring security.

The above-described characteristics of the embodiments of the present invention may be modified in a variety of ways by service providers, designers and vendors, and may be practiced in ways that have not been set forth in the above description. According to the embodiments of the present invention, the one or more tags 20a, 20b, 20c and the mobile communication terminal 10 that can perform NFC wireless communication are provided and the functions of the mobile communication terminal 10 can be compulsorily controlled by the tags 20a, 20b, 20c. Therefore, although variations and modifications have not been described in the above description, they should be interpreted as falling within the scope of the claims as long as they are within the range of the above-described technical spirit.

One or more of the embodiments of the present invention has the advantages of preventing the use of mobile communication terminals from inconveniencing people in a specific place such as a movie theater, a park, a bus or a public bath house and being convenient to operate thanks to there being no need for manipulation because function control commands to control functions of a mobile communication terminal in reader mode are stored in tags and the functions of a mobile communication terminal proximate to a communicative location can be compulsorily controlled.

Although the embodiments of the present invention have been disclosed for illustrative purposes, those skilled in the art will appreciate that various modifications, additions and substitutions are possible, without departing from the scope and spirit of the invention as disclosed in the accompanying claims

1. A Near Field Communication (NFC)-enabled mobile communication terminal capable of in reader mode, performing short-range wireless communication with at least one NFC tag, wherein the NFC-enabled mobile communication terminal comprises:
an NFC antenna for transmitting and receiving data recorded in the tag;
an NFC controller for receiving the data recorded in the tag via the NFC antenna;
a function control unit for receiving the data, read from the tag, from the NFC controller and analyzing the data; and
a terminal control unit for causing at least one function of the mobile communication terminal to be performed;
wherein the data recorded in the tag is function control data including a command to perform the at least one function of the mobile communication terminal;
wherein the function control unit extracts the command from the function control data, applies the command to the terminal control unit, and executes the command included in the function control data, thereby compulsorily controlling the function of the mobile communication terminal;
wherein the command comprises a plurality of commands to lock and unlock a plurality of functions of the mobile communication terminal; and
wherein the function control data individually or simultaneously locks or unlocks one or more functions via one or more commands selected from among the plurality of commands.

2. The NFC-enabled communication terminal as set forth in claim 1, wherein the NFC controller requests Identification (ID) information from the tag, checks if the tag is a valid communicative object, initiates NFC communication with the tag if the tag is the valid communicative object, and applies function control data, read from the tag, to the function control unit.

3. The NFC-enabled communication terminal as set forth in claim 1, wherein the tag comprises:
an ID information unit for storing ID information;
a command format unit for storing the at least one command to control the function of the mobile communication terminal; and
a tag communication unit for communicating with the mobile communication terminal in an NFC manner, and wirelessly transmitting and receiving function control data including the ID information stored in the ID information unit and the command stored in the command format unit and configured to control the function of the mobile communication terminal, to and from the mobile communication terminal.

4. The NFC-enabled communication terminal as set forth in claim 3, wherein the command format unit comprises a command to lock one or more functions of the mobile communication terminal and then unlock them after a predetermined time has elapsed.

5. A method of controlling an NFC-enabled mobile communication terminal capable of performing NFC communication with a tag storing both ID information and at least one command to control at least one function of the mobile communication terminal, the method comprising:
a reader mode switching step of switching to reader mode for reading data stored in the tag;
an ID information requesting step of, after the reader mode switching step, requesting the ID information from the tag;
a response receiving step of, after the ID information requesting step, receiving a response from the tag;
a session setup determining step of determining whether to set up a session with the tag by checking the ID information received at the response receiving step;
a data receiving step of, if it is determined at the session setup determining step that the ID information is valid ID information, setting up the session and receiving the data from the tag;
a command extracting step of extracting the command from the function control data, including the command to control the function of the mobile communication terminal, received at the data receiving step;
a command executing step of applying the command extracted at the command extracting step to a terminal control unit for controlling functions of the mobile communication terminal, thereby executing the command;
a result outputting step of outputting results of the execution of the command, performed at the command executing step, via a display;
wherein the command comprises a plurality of commands to lock and unlock a plurality of functions of the mobile communication terminal; and
wherein the function control data individually or simultaneously locks or unlocks one or more functions via one or more commands selected from among the plurality of commands.

6. The method as set forth in claim 5, wherein the command comprises a command to lock one or more selected functions and then unlock them after a predetermined time has elapsed.
